(19) United States
(12) Patent Application Publication
(10) Pub. No.: US 2026/0298168 A1
(43) Pub. Date: Oct. 1, 2026

(54) KNOCKING PREDICTION METHOD, KNOCKING PREDICTION DEVICE, ENGINE CONTROL DEVICE, VEHICLE, COMBUSTION DEVICE DESIGN METHOD, POWER GENERATION DEVICE DESIGN METHOD, VEHICLE DESIGN METHOD, AND FUEL DESIGN METHOD

(71) Applicant: TOHOKU UNIVERSITY, Sendai-shi, Miyagi (JP)

(72) Inventors: Kaoru MARUTA, Sendai-shi (JP); Yuhi MORII, Sendai-shi (JP)

(21) Appl. No.: 19/489,401

(22) PCT Filed: May 31, 2024
(86) PCT No.: PCT/JP2024/020120

§ 371 Date: Dec. 2, 2025

(30) Foreign Application Priority Data
Jun. 6, 2023 (WO) PCT/JP2023/020935

(51) Int. Cl. F02D 41/14

(52) U.S. Cl. CPC F02D 41/1498; F02D 2200/0606; F02D 2200/0614

(57) ABSTRACT

A knocking prediction method for predicting knocking that may occur in a premixed combustion field, includes a means for predicting knocking based on the finding that temporal changes in a normalized fuel mass fraction and a normalized temperature in zero-dimensional homogenous ignition are equivalent to a spatial change in one-dimensional laminar premixed flame in the premixed combustion field.

### TECHNICAL FIELD

The present disclosure relates to a knocking prediction method, a knocking prediction device, an engine control device, a vehicle, a method for designing a combustion device, a method for designing a power generation device, a method for designing a vehicle, and a method for designing a fuel.

### BACKGROUND ART

As is well known, in a premixed combustion type internal combustion engine such as a gasoline engine, suppression of knocking is an important design problem. Knocking is a phenomenon accompanied by shock waves generated by self-ignition of an unburned gas in a combustion chamber, and is likely to damage the engine. In a design of an internal combustion engine, a pressure and temperature (compression ratio) of the combustion chamber are reduced not to cause knocking.

On the other hand, as a knocking prediction method, the “Livengood-Wu integral” is well known. This “Livengood-Wu integral” is a scheme for estimating an ignition delay time when a pressure and temperature in the combustion chamber are changed and integrating the ignition delay time over time, and when a time integral value becomes “1”, self-ignition, that is, knocking occurs. The “Livengood-Wu integral” is widely used in the design of an actual engine as shown in Patent Literature 1 and 2 below.

### CITATION LIST

### Patent Literature

Patent Literature 1: JP 2004-332584 A
Patent Literature 2: JP 2007-127004 A

### SUMMARY OF INVENTION

### Technical Problem

Incidentally, although the “Livengood-Wu integral” is a simple scheme and can predict the occurrence of knocking (self-ignition) to some extent, prediction accuracy is not necessarily sufficient. In order to fully use the capability of an internal combustion engine functioning as a power generation device, it is strongly desired to establish a knocking prediction method having higher prediction accuracy than that of the “Livengood-Wu integral.”

The present disclosure has been made in view of the above circumstances, and an object thereof is to provide a knocking prediction method and a knocking prediction device, an engine control device, and a vehicle capable of further improving accuracy.

Another object of the present disclosure is to provide a combustion device, a power generation device, a method for designing a vehicle, a method for designing the combustion device that is capable of improving substantial performance of a fuel, a method for designing the power generation device, a method for designing the vehicle, and a method for designing the fuel.

### Solution to Problem

A knocking prediction method according to a first aspect of the present disclosure is a knocking prediction method for predicting knocking that may occur in a premixed combustion field, the knocking prediction method including: predicting knocking based on the finding that temporal changes in a normalized fuel mass fraction and a normalized temperature in zero-dimensional homogenous ignition are equivalent to a spatial change in a one-dimensional laminar premixed flame in the premixed combustion field.

A knocking prediction method according to a second aspect of the present disclosure is a knocking prediction method for predicting knocking that may occur in a premixed combustion field, the method including: determining that there is a likelihood of knocking in fuel with a Lewis-number greater than 1 and there is no likelihood of knocking in a fuel with a Lewis number smaller than 1 in a characteristic diagram showing a relationship between a normalized temperature and a normalized fuel mass fraction of a fuel.

A knocking prediction method according to a third aspect of the present disclosure is a knocking prediction method for predicting knocking that may occur in a premixed combustion field, the method including: a calculation step of sequentially calculating a burning velocity when an inlet temperature is gradually increased by a one-dimensional steady-state analysis of the premixed combustion field; a determination step of determining whether or not the burning velocity cannot be acquired because a flame cannot exist in the premixed combustion field; and an occurrence condition acquisition step of acquiring the inlet temperature corresponding to the burning velocity acquired last as a knocking occurrence condition.

A knocking prediction method according to a fourth aspect of the present disclosure is the knocking prediction method according to the third aspect, wherein the calculation step includes performing the calculation by reducing a size of a region including an unburned mixed gas, a reaction zone of the flame, and a burned gas in the premixed combustion field to a limit that the flame can encompass.

A knocking prediction method according to a fifth aspect of the present disclosure is the knocking prediction method according to the third or fourth aspect, wherein a fuel with a Lewis-number greater than 1 is a prediction target.

A knocking prediction device according to a first aspect of the present disclosure is a knocking prediction device for predicting knocking that may occur in a premixed combustion field, the knocking prediction device including a calculation means for sequentially calculating a burning velocity when an inlet temperature is gradually increased by a one-dimensional steady-state analysis of the premixed combustion field; a determination means for determining whether or not the burning velocity cannot be acquired because a flame cannot exist in the premixed combustion field; and an occurrence condition acquisition means for acquiring the inlet temperature corresponding to the burning velocity acquired last as a knocking occurrence condition.

A knocking prediction device according to a second aspect of the present disclosure is the knocking prediction device according to the first aspect, wherein the calculation means performs the calculation by reducing a size of a region including an unburned mixed gas, a reaction zone of the flame, and a burned gas in the premixed combustion field to a limit that the flame can encompass.

A knocking prediction device according to a third aspect of the present disclosure is the knocking prediction device according to the first or second aspect, wherein the calculation means sets a fuel with a Lewis-number greater than 1 as a calculation target.

An engine control device according to a first aspect of the present disclosure includes the knocking prediction device according to the first aspect or the second aspect, wherein the engine control device is configured to generate an engine control signal based on a knocking prediction result of the knocking prediction device.

An engine control device according to a second aspect of the present disclosure further includes a communication device capable of communicating with the outside, wherein at least the knocking prediction result and an engine operation amount indicated by the engine control signal are transmitted to the outside using the communication device.

An engine control device according to a third aspect of the present disclosure is the engine control device according to the second aspect, wherein the engine control device transmits, to the outside, engine-related information other than the engine control amount and the engine operation amount, in addition to the engine control amount.

A vehicle according to a first aspect of the present disclosure includes the engine control device according to the first aspect or the second aspect; and an engine controlled by the engine control device.

A method for designing a combustion device according to a first aspect of the present disclosure is a method for designing a combustion device based on a knocking occurrence condition estimated based on the knocking prediction method according to the third or fourth aspect.

A method for designing a power generation device according to a first aspect of the present disclosure is a method for designing a power generation device based on a knocking occurrence condition estimated based on the knocking prediction method according to the third or fourth aspect.

A method for designing a vehicle according to the first aspect of the present disclosure is a method for designing a vehicle based on a knocking occurrence condition estimated based on the knocking prediction method according to the third or fourth aspect.

A fuel design method according to the first aspect of the present disclosure is a method of designing a fuel based on a knocking occurrence condition estimated based on the knocking prediction method according to the third or fourth aspect.

### Advantageous Effects of Invention

According to the present disclosure, it is possible to provide a knocking prediction method, a knocking prediction device, a method for designing a combustion device, a method for designing a power generation device, a method for designing a vehicle, and a method for designing a fuel, which are capable of further improving the accuracy.

Further, according to the present disclosure, it is possible to provide a combustion device, a power generation device, a method for designing a vehicle, a method for designing the combustion device that is capable of improving substantial performance of a fuel, a method for designing the power generation device, a method for designing the vehicle, and a method for designing the fuel.

### BRIEF DESCRIPTION OF DRAWINGS

FIG. 1 is a flowchart illustrating a knocking prediction method according to an embodiment of the present disclosure.

FIG. 2 is a block diagram illustrating a functional configuration of a knocking prediction device according to an embodiment of the present disclosure.

FIG. 3 illustrates a list of various physical quantities used in theoretical description of the embodiment of the present disclosure.

FIG. 4 is a first characteristic diagram showing a knocking prediction characteristic in the embodiment of the present disclosure.

FIG. 5 is a second characteristic diagram showing a knocking prediction characteristic in the embodiment of the present disclosure.

FIG. 6 is a third characteristic diagram showing a knocking prediction characteristic in the embodiment of the present disclosure.

FIG. 7 is a characteristic diagram showing a comparative example of the knocking prediction method according to the embodiment of the present disclosure.

FIG. 8 is a block diagram illustrating an engine control device and a vehicle according to an embodiment of the present disclosure.

FIG. 9 is a schematic diagram illustrating external communication of a vehicle according to the embodiment of the present disclosure.

### DESCRIPTION OF EMBODIMENTS

Hereinafter, embodiments of the present disclosure will be described with reference to the drawings.

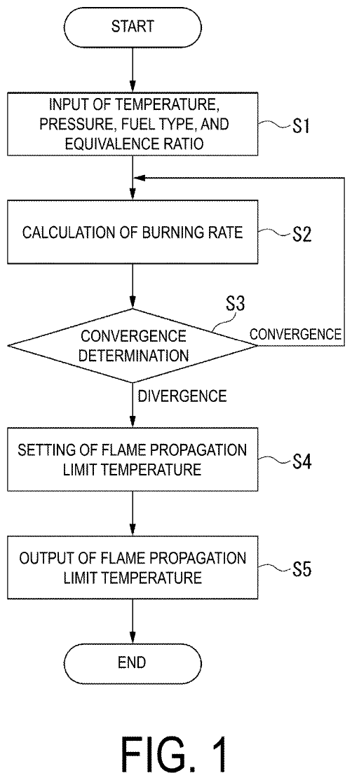

FIG. 1 is a flowchart illustrating a knocking prediction method according to the present embodiment. This flowchart shows a procedure for acquiring a flame propagation limit temperature, which is a knocking occurrence condition, that is, an initial temperature at which knocking occurs, for the premixed combustion field (the combustion chamber) in which a premixed gas including a fuel and air (oxidant) is ignited and combusted by a forced means such as spark ignition.

Further, the flowchart shows an overview of a processing procedure of a knocking prediction program (simulation program) executed by a predetermined computer. That is, the knocking prediction method according to the present embodiment is realized by information processing (simulation) using a computer.

A computer that executes the knocking prediction method according to the present embodiment, that is, a computer in which the knocking prediction program is installed is the knocking prediction device according to the present embodiment. That is, the knocking prediction device according to the present embodiment is a device that outputs the knocking occurrence condition in the premixed combustion field by executing the knocking prediction program.

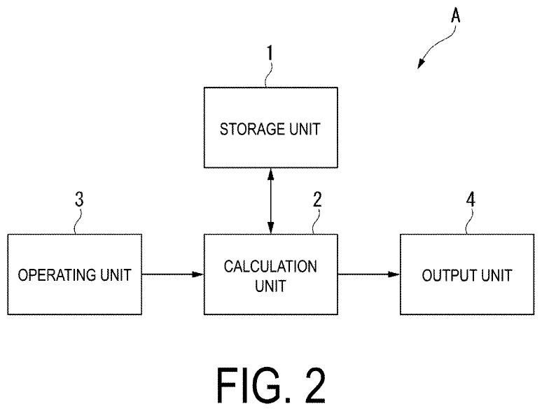

FIG. 2 is a block diagram illustrating a functional configuration of a knocking prediction device A according to the present embodiment. As illustrated in FIG. 2, the knocking prediction device A includes at least a storage unit 1 that stores the knocking prediction program in advance, a calculation unit 2 that executes the knocking prediction program, an operating unit 3 that inputs an operation instruction of an operator to the calculation unit 2, and an output unit 4 that outputs a calculation result of the calculation unit 2, that is, the flame propagation limit temperature (the initial temperature) to the outside.

Among the components of the knocking prediction device A, the storage unit 1, the calculation unit 2, and the operating unit 3 constitute a calculation means in the present disclosure. Although details will be described later, the storage unit 1, the calculation unit 2, and the operating unit 3 cooperate with each other to sequentially calculate the burning velocity when an inlet temperature is gradually increased by one-dimensional steady-state analysis of the premixed combustion field.

Further, the storage unit 1, the calculation unit 2, and the operating unit 3 in the knocking prediction device A constitute a determination means in the present disclosure. That is, the storage unit 1, the calculation unit 2, and the operating unit 3 cooperate to determine whether or not the burning velocity cannot be acquired because the flame cannot exist in the premixed combustion field.

Further, the storage unit 1, the calculation unit 2, and the operating unit 3 in the knocking prediction device A constitute an occurrence condition acquisition means in the present disclosure. That is, the storage unit 1, the calculation unit 2, and the operating unit 3 cooperate to acquire the inlet temperature (the flame propagation limit temperature) corresponding to the burning velocity acquired last as the knocking occurrence condition.

Here, a calculation means of the knocking prediction device A according to the present embodiment corresponds to a calculation step in the knocking prediction method according to the present embodiment. A determination means of the knocking prediction device A according to the present embodiment corresponds to a determination step in the knocking prediction method according to the present embodiment. Further, a raw condition acquisition means of the knocking prediction device A according to the present embodiment corresponds to an occurrence condition acquisition step in the knocking prediction method according to the present embodiment.

The premixed combustion field in the present embodiment is a combustion field corresponding to a combustion chamber of an internal combustion engine (prime mover) such as a gasoline engine mounted as a power generation device on a vehicle, for example. In designing gasoline engines and the like, measures such as lowering a compression ratio are taken to prevent knocking, that is, to prevent self-ignition of an unburned gas. The internal combustion engine includes a direct injection engine or an engine having a sub-chamber.

That is, the knocking prediction method according to the present embodiment relates to a method of designing a combustion device including a premixed combustion field (the combustion chamber), a power generation device (prime mover), a vehicle, and the like. The knocking prediction method according to the present embodiment also relates to a method of designing a fuel to be burned in the premixed combustion field.

The knocking prediction method according to the present embodiment is based on the premise that, when a time-space conversion of flame is applied to the premixed combustion field, a temporal change in a normalized fuel mass fraction and a normalized temperature in a zero-dimensional homogenous ignition are equivalent to a spatial change in the one-dimensional laminar premixed flame.

That is, the knocking prediction method is based on theoretical basis regarding the equivalence of the temporal change in the normalized fuel mass fraction and the zero-dimensional homogeneous ignition and the spatial change in the one-dimensional laminar premixed flame.

According to this theoretical basis, the degree of decrease in the normalized fuel mass fraction in a preheating zone of the premixed combustion field becomes higher in an order of the Lewis number of the fuel being smaller than 1, the Lewis number being 1 (=ignition), and the Lewis number being greater than 1. Further, it is derived that auto-ignition in the preheating zone near explosive transition can only occur for one-dimensional laminar premixed flame with a Lewis number greater than 1.

That is, a temporal change of a flame propagation is of the same order of magnitude as that of a premixed gas compressed in the premixed combustion field or the shock waves. It is also understood that the Lewis number of the fuel in the premixed combustion field is a physical quantity that determines the presence of a premixed flame structure.

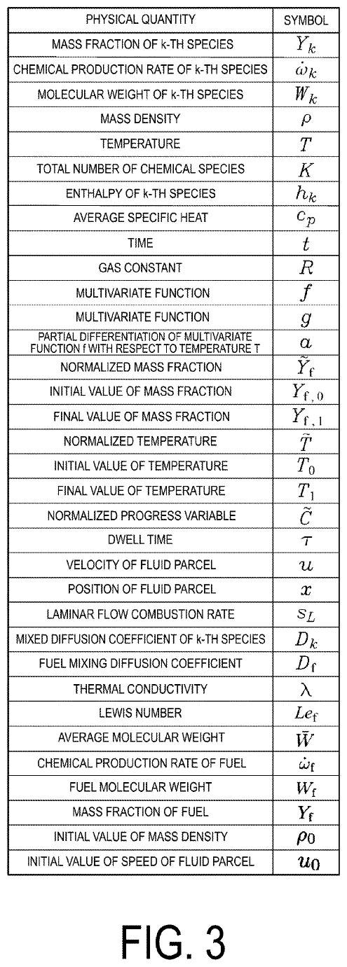

Hereinafter, a theoretical basis of the knocking prediction method according to the present embodiment will be described. FIG. 3 is a table listing various physical quantities to be dealt with in the following theoretical description.

Equations (1) and (2) below are governing equations of the zero-dimensional homogenous ignition using the normalized fuel mass fraction and the temperature. The governing equations (1) and (2) are conservation laws of energy and chemical species under constant pressure and constant enthalpy, and are given by a mass fraction of a k-th species, a chemical generation rate of the k-th species, a molecular weight of the k-th species, a mass density, a temperature, a total number of chemical species, the enthalpy of the k-th species, an average specific heat, and a time.

$$\begin{matrix}[ Math . 1 ] & \\ \frac{d {Y}_{k}}{d t} = \frac{{\dot{ω}}_{k} {W}_{k}}{ρ} ( k = 1 , 2 , … , K ) , & ( 1 )\end{matrix}$$

$$\begin{matrix} & \\ \frac{d T}{d t} = - \frac{{\sum }_{k = 1}^{K} {\dot{ω}}_{k} {h}_{k} {W}_{k}}{{c}_{p} ρ} & ( 2 )\end{matrix}$$

Further, the mass density is given as a gas state equation that is used for mutual conversion of pressure, density, and temperature as shown in Equation (3) below. In Equation (3), R is the universal gas constant.

$$\begin{matrix}[ Math . 2 ] & \\ ρ = \frac{p \overline{W}}{R T} , & ( 3 )\end{matrix}$$

Here, a Legendre transformation from a multivariate function f is considered. A total derivative of the multivariate function f characterizing a gas mixture with a temperature, mass density, mass fraction, and time as variables is given by Equation (4) below.

$$\begin{matrix}[ Math . 3 ] & \\ df ( T , ρ , Y , t ) = ( \frac{\partial f}{\partial T} ) dT + ( \frac{\partial f}{\partial ρ} ) d ρ + {\sum }_{k = 1}^{K} ( \frac{\partial f}{\partial {Y}_{k}} ) {dY}_{k} + ( \frac{θ f}{\partial t} ) dt & ( 4 )\end{matrix}$$

When the partial differential of the multivariate function f with respect to the temperature is substituted by “a” in Equation (4), a multivariate function g shown in Equation (5) below is obtained. The total differential of the multivariate function g is expressed by Equation (6) below with a, mass density, mass fraction, and time as variables. The total differential of the multivariate function g is expressed by Equation (7) below based on Equation (6).

$$\begin{matrix}[ Math . 4 ] & \\ g = a T - f . & ( 5 )\end{matrix}$$

$$dg = Tda - ( \frac{\partial f}{\partial ρ} ) d ρ - {\sum }_{k = 1}^{K} ( \frac{\partial f}{\partial {Y}_{k}} ) {dY}_{k} - ( \frac{df}{\partial t} ) dt . \qquad ( 6 )$$

$$dg = ( \frac{\partial f}{\partial ρ} ) da + ( \frac{\partial g}{\partial ρ} ) d ρ + {\sum }_{k = 1}^{K} ( \frac{\partial g}{\partial {Y}_{k}} ) {dY}_{k} + ( \frac{\partial g}{\partial t} ) dt . \qquad ( 7 )$$

Further, Equation (8) is obtained based on the comparison between Equations (6) and (7). Further, since Equation (5) above can be defined as shown in Equation (9), the relationship shown in Equation (10) is established between the multivariate function f and the multivariate function g.

$$\begin{matrix}[ Math . 5 ] & \\ ( \frac{\partial f}{\partial t} ) = - ( \frac{\partial g}{\partial t} ) . & ( 8 )\end{matrix}$$

$$g = f - aT . \qquad ( 9 )$$

$$( \frac{\partial f}{\partial t} ) = ( \frac{\partial g}{\partial t} ) . \qquad ( 10 )$$

Here, a candidate for the multivariate function f in Equations (8) and (10) is a normalized temperature. Further, as a candidate for the multivariate function g, the normalized fuel mass fraction in the case of a single-step chemical reaction model of Equation (8) or the normalized progress variable in the case of a multi-step chemical reaction model of Equation (10) is conceivable.

When the multivariate function f or the multivariate function g at a certain time is determined and when it is assumed that all the variables (time, mass density, and fuel mass fraction) representing characteristics of the premixed gas in the premixed combustion field can be determined, that is, when it is assumed that the multivariate function f and the multivariate function g depend only on a time direction, Equations (8) and (10) above can be rewritten from partial differential equations to ordinary differential equations.

As a result, when the normalized temperature is applied as the multivariate function f and the normalized fuel mass fraction is applied as the multivariate function g, Equation (8) above is expressed as Equation (11) below, which shows a relationship between a temporal change of the normalized temperature and a temporal change of the normalized fuel mass fraction. The normalized temperature is defined by Equation (12) below with the initial temperature and the final temperature as parameters. The normalized fuel mass fraction is defined by Equation (13) below with an initial fuel mass fraction and a final fuel mass fraction as parameters.

$$\begin{matrix}[ Math . 6 ] & \\ \frac{d \tilde{T}}{d t} = - \frac{d {\tilde{Y}}_{f}}{d t} . & ( 11 )\end{matrix}$$

$${\tilde{Y}}_{f} = \frac{{Y}_{f , 1} - {Y}_{f}}{{Y}_{f , 1} - {Y}_{f , 0}} , \qquad ( 12 )$$

$$\tilde{T} = \frac{T - {T}_{0}}{{T}_{1} - {T}_{0}} . \qquad ( 13 )$$

When the normalized temperature is applied as the multivariate function f and the normalized progress variable of the multi-step chemical reaction model is applied as the multivariate function g, Equation (10) above is expressed as Equation (14) below, which shows a relationship between the temporal change of the normalized temperature and the temporal change of the normalized progress variable.

$$\begin{matrix}[ Math . 7 ] & \\ \frac{d \tilde{T}}{d t} = \frac{d \tilde{C}}{dt} . & ( 14 )\end{matrix}$$

Here, in order to enable the Legendre transformation, the normalized temperature, the normalized fuel mass fraction, and the normalized progress variable need to be convex functions, a total differential of the normalized temperature needs to be a value greater than 0, a total differential of the normalized fuel mass fraction needs to be a value smaller than 0, and a total differential of the normalized progress variable needs to be a value greater than 0. This constraint always applies to the single-step chemical reaction model and usually also applies to the multi-step chemical reaction model.

In the following description, the normalized fuel mass fraction is taken as the multivariate function g and a sign is simply reversed for the normalized progress variable for simplicity of description. When either the normalized temperature or the normalized fuel mass fraction is determined, all remaining variables are determined. Based on this premise, Equations (1) and (2) are rewritten as Equations (15) and (16) below using the normalized temperature and the normalized fuel mass fraction.

$$\begin{matrix}[ Math . 8 ] & \\ \frac{d {\tilde{Y}}_{f}}{d t} = - \frac{{\dot{ω}}_{f} {W}_{f}}{ρ ( {Y}_{f , 1} - {Y}_{f , 0} )} = - \frac{1}{{Y}_{f , 1} - {Y}_{f , 0}} \frac{{dY}_{f}}{dt} , & ( 15 )\end{matrix}$$

$$\frac{d \tilde{T}}{d t} = - \frac{{\sum }_{k = 1}^{K} {\dot{ω}}_{f} {h}_{k} {W}_{k}}{{c}_{p} ρ ( {T}_{1} - {T}_{0} )} = \frac{1}{{T}_{1} - {T}_{0}} \frac{d T}{dt} . \qquad ( 16 )$$

As shown in Equation (11) above, a relationship between the normalized temperature and the normalized fuel mass fraction is independent of time. Therefore, Equation (11) can be rewritten by using a dwell time as follows: The dwell time is defined by Equation (18) below, which includes a velocity of a fluid parcel and a position of the fluid parcel, and is a total time that a fluid parcel spends in a control volume. A total derivative of the dwell time is expressed by Equation (19) below.

$$\begin{matrix}[ Math . 9 ] & \\ \frac{d \tilde{T}}{d τ} = - \frac{d {\tilde{Y}}_{f}}{d τ} & ( 17 )\end{matrix}$$

$$τ = {\int }_{{x}_{0}}^{x} \frac{1}{u} dx , \qquad ( 18 )$$

$$d τ = \frac{1}{u} dx . \qquad ( 19 )$$

By transforming Equations (15) and (16) using Equation (19), Equations (20) and (21) below are obtained. Further, Equation (17) can be rewritten as Equation (22) below by using the position of the parcel. Further, the relationship shown in Equation (23) is established based on Equation (22).

$$\begin{matrix}[ Math . 10 ] & \\ ρ u \frac{d {\tilde{Y}}_{f}}{dx} = - \frac{{\dot{ω}}_{f} {W}_{f}}{{Y}_{f , 1} - {Y}_{f , 0}} & ( 20 )\end{matrix}$$

$$ρ u \frac{d \tilde{T}}{dx} = - \frac{{\sum }_{k = 1}^{K} {\dot{ω}}_{f} {h}_{k} {W}_{k}}{{c}_{p} ( {T}_{1} - {T}_{0} )} . \qquad ( 21 )$$

$$\frac{d \tilde{T}}{dx} = - \frac{d {\tilde{Y}}_{f}}{dx} . \qquad ( 22 )$$

$$\frac{{\sum }_{k = 1}^{K} {\dot{ω}}_{f} {h}_{k} {W}_{k}}{{c}_{p} ( {T}_{1} - {T}_{0} )} = - \frac{{\dot{ω}}_{f} {W}_{f}}{{Y}_{f , 1} - {Y}_{f , 0}} . \qquad ( 23 )$$

On the other hand, a conservation equation of the one-dimensional laminar premixed flame is given by Equations (24) to (26) below, which include a laminar burning velocity, a mixing diffusion coefficient of the k-th species, and thermal conductivity of the premixed gas: Further, Equations (25) and (26) can be rewritten as Equations (27) and (28) below by using the normalized temperature and the normalized fuel mass fraction.

$$\begin{matrix}[ Math . 11 ] & \\ ρ u = constant = {ρ}_{0} {u}_{0} = {ρ}_{0} {s}_{L} , & ( 24 )\end{matrix}$$

$$ρ u \frac{d {Y}_{k}}{d x} = \frac{d}{d x} ( ρ {D}_{k} \frac{d {Y}_{k}}{d x} ) + {\dot{ω}}_{k} {W}_{k} , \qquad ( 25 )$$

$$ρ u \frac{d T}{d x} = \frac{1}{{c}_{p}} \frac{d}{d x} ( λ \frac{d T}{d x} ) - \frac{{\sum }_{k = 1}^{K} {\dot{ω}}_{k} {h}_{k} {W}_{k}}{{c}_{p}} , \qquad ( 26 )$$

$$\begin{matrix}[ Math . 12 ] & \\ ρ u \frac{d {\tilde{Y}}_{f}}{d x} = \frac{d}{d x} ( ρ {D}_{f} \frac{d {\tilde{Y}}_{f}}{d x} ) - \frac{{\dot{ω}}_{f} {W}_{f}}{{Y}_{f , 1} - {Y}_{f , 0}} , & ( 27 )\end{matrix}$$

$$ρ u \frac{d \tilde{T}}{d x} = \frac{1}{{c}_{p}} \frac{d}{d x} ( λ \frac{d \tilde{T}}{d x} ) - \frac{{\sum }_{k = 1}^{K} {\dot{ω}}_{k} {h}_{k} {W}_{k}}{{c}_{p} ( {T}_{1} - {T}_{0} )} . \qquad ( 28 )$$

By substituting Equations (22) and (23) into Equation (27), Equation (29) below is obtained. As can be seen from a comparison between Equation (29) and Equation (28), a difference between the two equations is only the first term on the right side.

$$\begin{matrix}[ Math . 13 ] & \\ ρ u \frac{d \tilde{T}}{d x} = \frac{d}{d x} ( ρ {D}_{f} \frac{d \tilde{T}}{d x} ) - \frac{{\sum }_{k = 1}^{K} {\dot{ω}}_{k} {h}_{k} {W}_{k}}{{c}_{p} ( {T}_{1} - {T}_{0} )} . & ( 29 )\end{matrix}$$

Here, the Lewis number of the fuel is defined by Equation (30) below. When Equations (28) and (29) are compared with each other by focusing on the Lewis number, it is understood that both the equations become equal to each other when the Lewis number is 1. That is, for the fuel with a Lewis number of 1, a temporal change in the normalized fuel mass fraction and the normalized temperature in the zero-dimensional homogenous ignition is equivalent to a spatial change in the one-dimensional laminar premixed flame.

$$\begin{matrix}[ Math . 14 ] & \\ L {e}_{f} = \frac{λ}{ρ {c}_{p} {D}_{f}} . & ( 30 )\end{matrix}$$

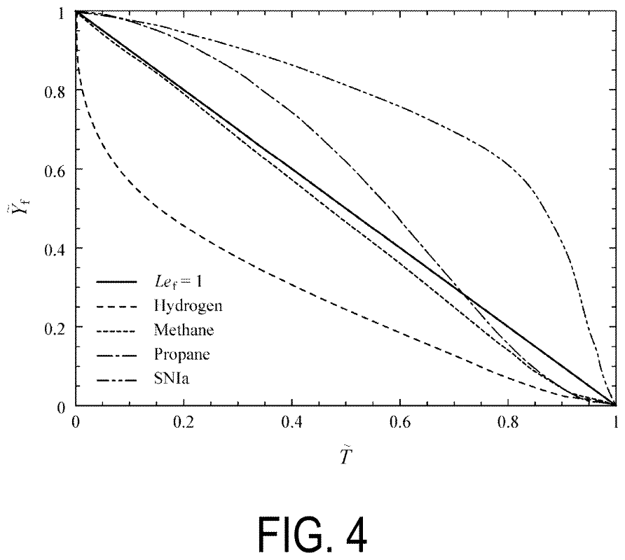

FIG. 4 is a characteristic diagram showing a relationship between the zero-dimensional homogenous ignition and the one-dimensional laminar premixed flame in the premixed combustion field when hydrogen, methane, propane, and SNIa are used as fuels. SNIa indicates a carbon state in a nuclear combustion process of a type Ia supernovas, and has a very high Lewis number. Hydrogen, methane, and propane have Lewis numbers of 0.36, 0-96 and 1.95.

As described above, for the fuel with a Lewis number of 1, the zero-dimensional homogenous ignition indicated by the normalized fuel mass fraction and the normalized temperature is equivalent to the one-dimensional laminar premixed flame indicated by the normalized fuel mass fraction and the normalized temperature. Also, for the fuel with a Lewis number smaller than 1, a profile of the one-dimensional laminar premixed flame is more convex below a profile of the fuel with a Lewis-number of 1 (the zero-dimensional homogenous ignition).

On the other hand, for a fuel with a Lewis-number greater than 1, the profile is convex above that of the fuel with a Lewis-number of 1 (the zero-dimensional homogenous ignition) and is likely to intersect with the profile of the fuel with a Lewis-number of 1 (the zero-dimensional homogenous ignition) in a high-temperature region of the flames (reaction zone) in which heat release is high.

This indicates that, in the fuel with a Lewis number smaller than 1, the fuel is diffused preferentially rather than being heated because a material diffusion coefficient of the fuel is greater than a thermal diffusion coefficient. On the other hand, in the case of the fuel with a Lewis-number greater than 1, the fuel is heated preferentially to being diffused because thermal diffusion coefficient of the fuel is greater than a material diffusion coefficient.

That is, the fact that the fuel with a Lewis-number greater than 1 is preferentially heated rather than being diffused is consistent with well-known technical knowledge. The influence of the Lewis number on a relationship between the temperature and the fuel mass fraction is discussed theoretically in the well-known Buckmaster book, and the characteristic of FIG. 4 is consistent with that theory.

Hereinafter, a region at a relatively low temperature (preheating zone) in which an influence of the Lewis number on the premixed combustion field is clear will be examined. It is assumed that a well-known Soret effect and a well-known Duffer effect are negligible in this study.

In the characteristic diagram of FIG. 4, the consumption of the normalized fuel mass fraction at a predetermined normalized temperature can be regarded as a degree of progress of the combustion reaction. That is, the degree of progress of the combustion reaction follows an order of the fuel with a Lewis number smaller than 1, a fuel having a Lewis number of 1 (the zero-dimensional homogenous ignition), and a fuel with a Lewis-number greater than 1.

In the case of the fuel with a Lewis number smaller than 1, self-ignition (knocking) does not occur in the preheating zone. That is, even when the initial temperature and the initial pressure in the premixed combustion field are very high, there may be the one-dimensional laminar premixed flame. On the other hand, in the fuel with a Lewis-number greater than 1, there is a likelihood that the self-ignition (knocking) occurs in the preheating zone. That is, there is no one-dimensional laminar premixed flame depending on the initial temperature and the initial pressure in the premixed combustion field.

For example, since gasoline, which is one of the fuels, has the Lewis-number greater than 1, it is expected that self-ignition (knocking) occurs each time an unburned gas region rises to a temperature and a pressure at which the flame propagation is impossible. That is, a transition from the flame propagation to detonation may be influenced because a characteristic time of the flame behind the shock waves is of the same order of magnitude as at ignition. Also, in gasoline, since the Lewis number is greater than 1, there may be a region behind the shock waves in which the flame propagation is not possible.

Simulation (the one-dimensional steady-state analysis) was performed on two premixed gases, that is, a premixed gas (hydrogen fuel) of hydrogen and air with a Lewis number smaller than 1 and a premixed gas (n-heptane fuel) of n-heptane and air with a Lewis-number greater than 1, for the zero-dimensional homogenous ignition and the one-dimensional laminar premixed flame, under constant pressure and constant enthalpy conditions.

In this simulation, the one-dimensional steady-state analysis of the zero-dimensional homogenous ignition and the one-dimensional laminar premixed flame was performed by using a well-known multi-step chemical model. The multi-step chemical reaction model of the hydrogen fuel is a well-known UT-JAXA model, and the multi-step chemical reaction model of the n-heptane fuel is a well-known reduced SIP model.

In this simulation, a calculation region should be as short as possible, since the normalized temperature and the normalized fuel mass fraction should be convex functions in order to maintain the Legendre transformation. Therefore, in this simulation, a size of a region including an unburned mixed gas, a reaction zone of the flame, and a burned gas in the premixed combustion field is set to be small to a limit that the flame can encompass. Numerical conditions (initial conditions) of pressure and an equivalence ratio are fixed values of, for example, 0.1 MPa and 1.0.

Further, in this simulation, the one-dimensional steady-state analysis of the one-dimensional laminar premixed flame was performed by changing the inlet temperature from 300 to 3000K in increments of 100K. When a calculation failure has been confirmed even when the calculation region is reduced, numerical calculation was executed by changing the inlet temperature in 1K increments.

Further, in this simulation, after the one-dimensional steady-state analysis of the one-dimensional laminar premixed flame was performed, a numerical calculation of the zero-dimensional homogenous ignition was performed using the initial temperature from which the one-dimensional laminar premixed flame could be calculated.

Such a simulation (one-dimensional steady-state analysis) corresponds to the knocking prediction method according to the present embodiment. Further, this simulation is a processing operation of the knocking prediction device according to the present embodiment, that is, information processing that is executed by the calculation unit 2 based on the knocking prediction program stored in advance in the storage unit 1.

That is, in the knocking prediction method according to the present embodiment, first, the operator operates the operating unit 3 to input, to the calculation unit 2, a temperature, a pressure, a type of fuels such as hydrogen or n-heptane, and an equivalence ratio, which are initial conditions necessary for simulation (step S1).

The calculation unit 2 calculates the flame propagation limit temperature regarding each fuel by using the temperature, the pressure, the fuel type, and the equivalence ratio input in step S1 and executing the one-dimensional steady-state analysis (calculation step) while gradually increasing the inlet temperature (calculation start temperature) (step S2).

The one-dimensional steady-state analysis is a convergent calculation that contracts a flame front and a flame back until a one dimensional premixed flame structure becomes a narrowest calculation region that is a unique solution. That is, the calculation unit 2 sequentially calculates the burning velocity when the inlet temperature is gradually increased by the one-dimensional steady-state analysis of the premixed combustion field, but the calculation of the burning velocity may converge or diverge according to a set value of the inlet temperature.

The calculation unit 2 performs convergence determination (determination step) for each calculation of the burning velocity regarding a certain inlet temperature (calculation start temperature) (step S3). That is, in step S3, the calculation unit 2 determines whether or not the burning velocity cannot be acquired because the flames cannot exist in the premixed combustion field. When the determination result of step S3 is “convergence”, the calculation unit 2 sets the inlet temperature to be higher and executes the calculation of the burning velocity.

On the other hand, when the determination result of step S3 is “divergence”, the calculation unit 2 sets the inlet temperature corresponding to the previous calculation of the burning velocity as the flame propagation limit temperature (step S4: occurrence condition acquiring step). That is, the calculation unit 2 acquires the flame propagation limit temperature (inlet temperature) corresponding to the burning velocity acquired last as the knocking occurrence condition. The calculation unit 2 outputs, to the output unit 4, a simulation result including the flame propagation limit temperature acquired in this manner as the knocking occurrence condition.

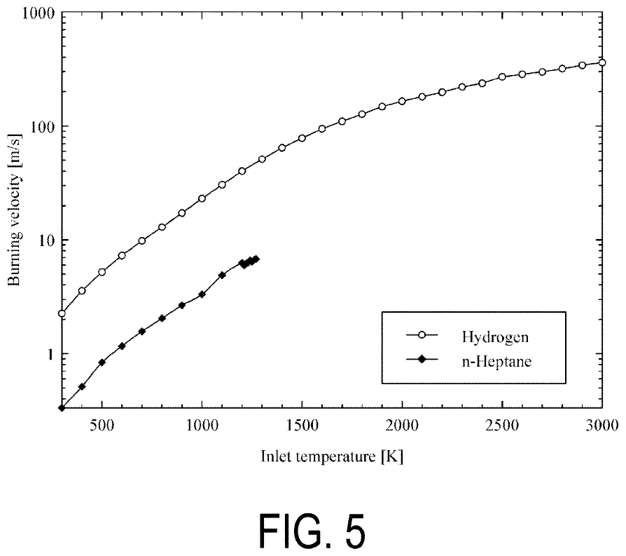

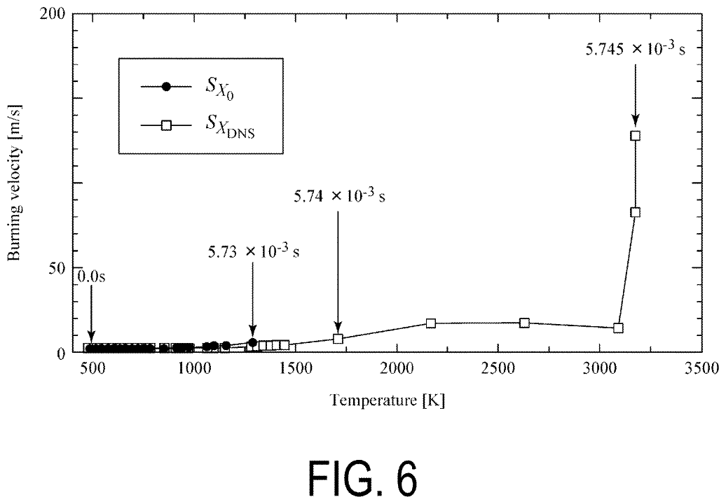

FIG. 5 shows an example of the simulation result (one-dimensional steady-state analysis result), that is, a calculation result including the knocking occurrence condition output from the calculation unit 2 to the output unit 4. Further, FIG. 6 shows an example of a relationship between the inlet temperature and the burning velocity of the premixed combustion field based on the simulation results. In FIG. 6, black circles represent simulation results (one-dimensional steady-state analysis results) in the present embodiment, and squares represent results of direct numerical simulation (DNS) shown as a comparative example.

FIG. 6 shows that, in the case of the hydrogen fuel, the burning velocity increases with an increasing inlet or initial temperature, and propagating flames are present even at the inlet temperature of the 3000K. Further, this FIG. 6 shows that for n-heptane fuels, the burning velocity increases with increase in inlet temperature, but propagating flames cannot exist beyond the 1270K.

That is, theoretical basis in the present embodiment is that a relationship between the normalized fuel mass fraction and the normalized temperature is theoretically shown to be equivalent for the zero-dimensional homogenous ignition and the one-dimensional laminar premixed flame with a Lewis-number of 1 after space-time conversion, and that the Lewis-number is a physical quantity that determines the presence of premixed flames structure near the explosive transition of the flame in the premixed combustion field.

For one-dimensional laminar premixed flame of the fuel with a Lewis number smaller than 1, no ignition occurs in the preheating zone, and thus the flame structure is always present. On the other hand, for the one-dimensional laminar premixed flame of the fuel with a Lewis number greater than 1, there is a likelihood of ignition in the preheat zone, and when the temperature is above a certain threshold, there is no flame structure.

In other words, when a characteristic time of ignition and flame is of the same order of magnitude as the back of the shock waves or the explosive transition of an SI engine, the ignition and the flame should be discussed via the Lewis number.

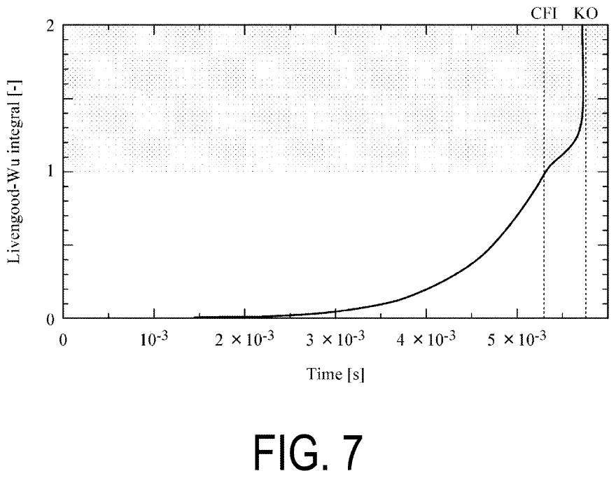

FIG. 7 illustrates a comparative example of the present embodiment. That is, this comparative example is a calculation result of “Livengood-Wu integral” by the direct numerical simulation (DNS). It is well known that the direct numerical direct numerical simulation (DNS) is for simulating a combustion state of the premixed combustion field with high accuracy. Further, as is well known, the “Livengood-Wu integral” is a characteristic that self-ignition (knocking) occurs when the time integral value becomes 1.

However, according to the calculation result, knocking does not occur at a time point (CFI) when the time integral value becomes 1. According to the calculation result, knocking occurs at a time point (KO) after the time integral value exceeds 1. Therefore, the knocking prediction method based on the “Livengood-Wu integral” has a problem in terms of accuracy.

On the other hand, since the present embodiment is based on the finding that the temporal changes in the normalized fuel mass fraction and the normalized temperature in the zero-dimensional homogenous ignition are equivalent to the spatial change in the one-dimensional laminar premixed flame, the accuracy is higher than that of the “Livengood-Wu integral.” That is, according to the present embodiment, it is possible to provide a knocking prediction method and a knocking prediction device capable of further improving the accuracy.

Further, the knocking prediction method and the knocking prediction device according to the present embodiment have high knocking prediction accuracy, and thus provide a great benefit to the design of a combustion device, a power generation device (internal combustion engine), a vehicle, a fuel, and the like.

For example, in the field of designing the combustion device, a recovery rate of thermal energy needs to be sacrificed to some extent in order to avoid damage to the device due to knocking. Further, in the field of designing power generation devices (internal combustion engines) and vehicles, output needs to be sacrificed to some extent in order to avoid damage to the device due to knocking.

In the field of designing such a combustion device, a power generation device (internal combustion engine), a vehicle, and the like, the improvement in the accuracy of knocking prediction makes it possible to reduce the recovery rate of thermal energy and the sacrifice of output. That is, according to the knocking prediction method and the knocking prediction device of the present embodiment, it is possible to estimate a margin for knocking, which should be taken into consideration in designing a combustion device, a power generation device, a vehicle, and the like, more narrowly than before.

Therefore, by designing the combustion device, the power generation device (internal combustion engine), the vehicle, and the like based on the knocking occurrence condition estimated by the knocking prediction method and the knocking prediction device according to the present embodiment, it is possible to realize a design that improves the performance of the combustion device, the power generation device (internal combustion engine), the vehicle, and the like.

According to the knocking prediction method and the knocking prediction device of the present embodiment as described above, it is possible to provide a method of designing a combustion device, a method of designing a power generation device, and a method of designing a vehicle, which are capable of improving the performance of the combustion device, the power generation device, the vehicle, and the like.

In the method of designing a combustion device, the method of designing a power generation device, and the method of designing a vehicle as described above, it is conceivable that the fuel with a Lewis-number greater than 1 is a prediction target (calculation target). That is, as shown in the characteristic diagram of FIG. 4, since there is no concern that knocking occurs in the fuel with a Lewis number smaller than 1, the fuel may be excluded from the prediction target (calculation target).

Further, according to the knocking prediction method and the knocking prediction device of the present embodiment, it is possible to predict knocking with high accuracy for each type of fuel, and therefore, it is possible to contribute to the design of the fuel that avoids knocking. Therefore, according to the knocking prediction method and the knocking prediction device of the present embodiment, it is possible to provide a fuel setting method capable of improving the performance of the fuel.

Here, in the present embodiment, the effectiveness of the present disclosure has been described for a single-component fuel (pure substance fuel) such as “hydrogen” or “n-heptane” as an example of an evaluation target fuel for knocking prediction. However, the present disclosure is also applicable to other pure substance fuels such as methane and propane.

In the present embodiment, knocking of the evaluation target fuel is predicted based on one-dimensional steady-state analysis (simulation) regarding the evaluation target fuel. Therefore, the present disclosure is not limited to a pure substance fuel as long as the one-dimensional steady-state analysis (simulation) is possible, and can be applied to a multi-substance fuel in which a plurality of components are mixed.

As is well known, in order to execute the one-dimensional steady-state analysis (simulation) of the fuel, it is necessary to specify chemical species involved in a combustion phenomenon of the fuel and elementary reactions based on the chemical species. Fuels for which chemical species and elementary reactions are specified at a current time point include, for example, surrogate fuels including up to five components defined in an Innovative Combustion Technology (SIP) surrogate chemical reaction mechanism. In a SIP surrogate chemical reaction mechanism, the chemical species and the elementary reactions are not specified for a multi-substance fuel composed of six or more components.

However, it is expected that chemical species and elementary reactions of multi-substance fuels including six or more components will be specified in the future. That is, it is sufficiently assumed that the chemical species and the elementary reactions are specified and the one-dimensional steady-state analysis (simulation) is possible even for the multi-substance fuel including six or more components, and it is presumed that knocking prediction based on the present disclosure is sufficiently possible.

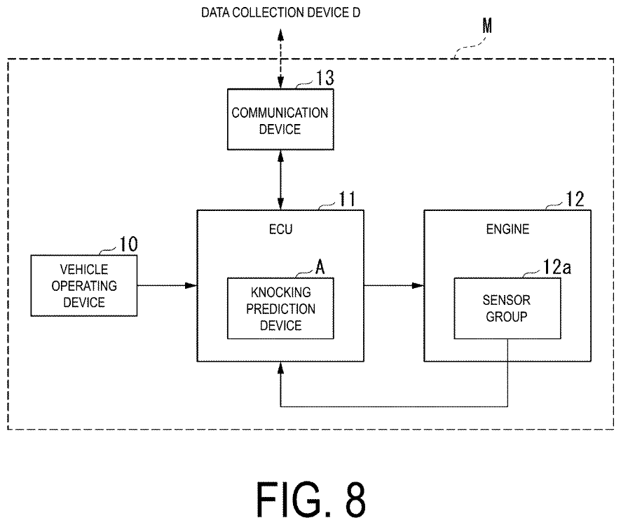

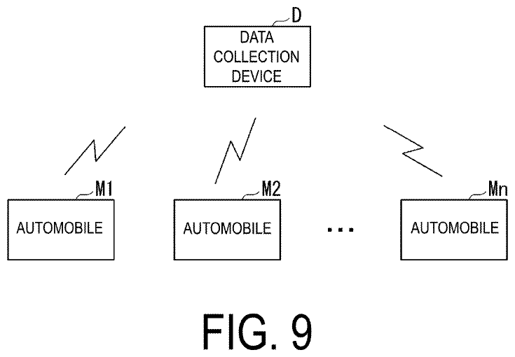

Next, an engine control device (ECU: Electronic Control Unit) and a vehicle (automobile) according to the present embodiment will be described with reference to FIGS. 8 and 9.

The engine control device according to the present embodiment is an electronic control unit (ECU) 11 illustrated in FIG. 8. Further, a vehicle according to the present embodiment is an automobile M including a vehicle operating device 10, an ECU 11, an engine 12, and a communication device 13, as illustrated in FIG. 8.

The vehicle operating device 10 is an operation panel of the automobile M, and generates an operation instruction signal based on an input operation of a driver and outputs the operation instruction signal to the ECU 11. That is, the operation instruction signal is a signal indicating an operation instruction of the driver with respect to the automobile M.

The ECU 11 is a so-called embedded computer, and includes an arithmetic circuit, a storage circuit, and an input and output circuit. The ECU 11 controls the engine 12 by executing an engine control program stored in advance in the storage circuit.

That is, the ECU 11 generates various engine control signals by executing an engine control program by an arithmetic circuit. The engine control signal is a signal indicating various operation amounts (engine operation amounts) for the engine 12, such as an opening degree of an air supply valve and an opening degree or timing of a fuel injection valve. The ECU 11 controls the engine 12 by outputting such an engine control signal to the engine 12 using the input and output circuit.

The engine 12 is an internal combustion engine that generates power by combusting fuel in a combustion chamber, and includes a sensor group 12a including a plurality of sensors. The sensor group 12a detects various state amounts relating to the engine 12, such as the opening degree of an air supply valve, an operation of a fuel injection valve, and carbon dioxide contained in exhaust gas, as an engine control amount, and outputs the engine control amount to the ECU 11 as sensor signals.

When generating the engine control signal, the ECU 11 refers to the operation instruction signal input from the vehicle operating device 10 and various sensor signals input from the sensor group 12a. The ECU 11 performs information processing on the operation instruction signal and the engine control amount according to an engine control program to generate the engine control signal (the engine operation amount).

As illustrated in FIG. 8, the ECU 11 in the present embodiment includes the above-described knocking prediction device A. The knocking prediction device A is a computer that predicts the occurrence of knocking by executing the knocking prediction program stored in advance in the storage unit 1 by the calculation unit 2 as described above.

When fuel is supplied to the automobile M, the knocking prediction device A in the ECU 11 derives a composition of the fuel from big data based on information collected from surrounding vehicles from date and time and position information, and executes the knocking prediction program for the composition of the fuel to acquire a knocking occurrence prediction result. That is, an acquisition timing of a knocking occurrence prediction result is a timing immediately after the automobile M is refueled and before the automobile M starts traveling. Further, the reexamination of the fuel composition is constantly updated from the operating conditions of the automobile M while the automobile M is traveling, and when a deviation from the initially predicted fuel composition becomes large, the knocking occurrence prediction result is also updated. Further, the updated information is transmitted by data communication such as radio communication, and is accumulated as big data contributing to surrounding vehicles or development/improvement.

The ECU 11 in the present embodiment is a built-in computer that includes the knocking prediction device A as an additional function association with an engine control function by storing the knocking prediction program in advance in addition to the engine control program. Such an ECU 11 refers to the knocking prediction result obtained by executing the knocking prediction program in generating the engine control signal. For example, when the occurrence of knocking is predicted by the execution of the knocking prediction program, the ECU 11 generates an engine control signal to avoid knocking.

Further, the ECU 11 in the present embodiment provides the knocking prediction result based on the knocking prediction program, the engine operation amount indicated by the engine control signal, and the engine control amount obtained by the sensor group 12a to an external data collection device D together with the supplementary information. The supplementary information is engine-related information other than the engine control amount and the engine operation amount, and is, for example, a date, a time, an outside air temperature, a season, a fuel composition, and a traveling position of the automobile M.

That is, the ECU 11 sequentially stores the knocking prediction result acquired before the automobile M travels, and the engine operation amount, the engine control amount, and the supplementary information sequentially obtained in time series during the traveling of the automobile M in the storage circuit as learning data (time-series data). The ECU 11 reads out such learning data from the storage circuit at a predetermined timing and outputs the learning data to the communication device 13.

The communication device 13 is a wireless communication device that is provided between the ECU 11 and the data collection device D and mediates communication between the ECU 11 and the data collection device D. That is, the communication device 13 converts the training data input from the ECU 11 into a radio signal and transmits the radio signal to the data collection device D.

As illustrated in FIG. 9, such learning data is provided to the data collection device D from plurality of automobiles MI to Mn (n: natural number equal to or greater than 2) included in the ECU 11 including the knocking prediction device A. That is, the learning data related to the plurality of automobiles MI to Mn is sequentially accumulated in the data collection device D as big data.

Since individual learning data of such big data includes the knocking prediction result corresponding to the engine operation amount, the engine control amount, and the supplementary information, various utilization methods are conceivable.

For example, in a hybrid engine, knocking is avoided by switching to a motor under a condition that knocking occurs or by strengthening motor assistance, and the big data in the present embodiment can be data useful for design consideration of such knocking avoidance.

Further, by comparing the big data analysis of the engine performance with the big data in the present embodiment, it is possible to detect a failure including a defect of the pressure sensor when the performance is not higher than predicted performance, and provide information on a change over time, a failure, and deterioration of the engine 12, thereby improving maintainability.

Further, by sharing big data in the present embodiment, it is possible to utilize the big data for cloud-based vehicle diagnosis or optimal engine operation parameters. Further, by mixing a hydrocarbon such as light oil or a different type of fuel with gasoline as a hybrid fuel system, the ignitability is increased, and thus the burning velocity is increased, which can lead to an improvement in safety.

Further, since the type of fuel varies depending on a country or region where the fuel is sold, knocking is suppressed by preparing data describing optimal combustion conditions, but in the present invention, it is also possible to omit such a data collection or input process at the time of automobile manufacture. Further, in the case of an automobile with the function according to the present invention, an effect of knocking suppression can be obtained without passing through a process of inputting data in advance even with a new composition fuel such as e-fuel that will appear after sale. Further, in a case in which the sub-chamber is provided in the combustion chamber of the engine 12, it is possible to flexibly control the ignitability and thus to improve thermal efficiency.

### INDUSTRIAL APPLICABILITY

The present disclosure can be used for a knocking prediction method, a knocking prediction device, an engine control device, a vehicle, a method for designing a combustion device, a method for designing a power generation device, a method for designing a vehicle, and a method for designing a fuel.

### REFERENCE SIGNS LIST

A Knocking prediction device
D Data collection device
M Automobile (vehicle)
1 Storage unit
2 Calculation unit
3 Operating unit
4 Output unit
10 Vehicle operation device
11 ECU (engine control device)
12 Engine
12a Sensor group
13 Communication device

1. A knocking prediction method for predicting knocking that may occur in a premixed combustion field, the knocking prediction method comprising:
predicting knocking based on the finding that temporal changes in a normalized fuel mass fraction and a normalized temperature in zero-dimensional homogenous ignition are equivalent to a spatial change in one-dimensional laminar premixed flame in the premixed combustion field.

2. A knocking prediction method for predicting knocking that may occur in a premixed combustion field, the method comprising:
determining that there is a likelihood of knocking in fuel with a Lewis-number greater than 1 and there is no likelihood of knocking in a fuel with a Lewis number smaller than 1 in a characteristic diagram showing a relationship between a normalized temperature and a normalized fuel mass fraction of a fuel.

3. A knocking prediction method for predicting knocking that may occur in a premixed combustion field, the method comprising:
a calculation step of sequentially calculating a burning velocity when an inlet temperature is gradually increased by a one-dimensional steady-state analysis of the premixed combustion field;
a determination step of determining whether or not the burning velocity cannot be acquired because a flame cannot exist in the premixed combustion field; and
an occurrence condition acquisition step of acquiring the inlet temperature corresponding to the burning velocity acquired last as a knocking occurrence condition.

4. The knocking prediction method according to claim 3, wherein the calculation step includes performing the calculation by reducing a size of a region including an unburned mixed gas, a reaction zone of the flame, and a burned gas in the premixed combustion field to a limit that the flame can encompass.

5. The knocking prediction method according to claim 3, wherein a fuel with a Lewis-number greater than 1 is a prediction target.

6. A knocking prediction device for predicting knocking that may occur in a premixed combustion field, the knocking prediction device comprising:
a calculation means for sequentially calculating a burning velocity when an inlet temperature is gradually increased by a one-dimensional steady-state analysis of the premixed combustion field;
a determination means for determining whether or not the burning velocity cannot be acquired because a flame cannot exist in the premixed combustion field; and
an occurrence condition acquisition means for acquiring the inlet temperature corresponding to the burning velocity acquired last as a knocking occurrence condition.

7. The knocking prediction device according to claim 6, wherein the calculation means performs the calculation by reducing a size of a region including an unburned mixed gas, a reaction zone of the flame, and a burned gas in the premixed combustion field to a limit that the flame can encompass.

8. The knocking prediction device according to claim 6, wherein the calculation means sets a fuel with a Lewis-number greater than 1 as a calculation target.

9. A method of designing a combustion device, comprising: designing a combustion device based on the knocking occurrence condition estimated based on the knocking prediction method according to claim 3.

10. A method of designing a power generation device, comprising: designing the power generation device based on the knocking occurrence condition estimated based on the knocking prediction method according to claim 3.

11. A vehicle design method for designing a vehicle based on the knocking occurrence condition estimated based on the knocking prediction method according to claim 3.

12. A fuel design method for designing a fuel based on the knocking occurrence condition estimated based on the knocking prediction method according to claim 3.

13. An engine control device comprising:
the knocking prediction device according to claim 6,
wherein the engine control device is configured to generate an engine control signal based on a knocking prediction result of the knocking prediction device.

14. The engine control device according to claim 13, further comprising:
a communication device capable of communicating with the outside,
wherein at least the knocking prediction result and an engine operation amount indicated by the engine control signal are transmitted to the outside using the communication device.

15. The engine control device according to claim 14, wherein the engine control device transmits, to the outside, engine-related information other than the engine control amount and the engine operation amount, in addition to the engine control amount.

16. A vehicle comprising:
the engine control device according to claim 13; and
an engine controlled by the engine control device.
